(19) United States
(12) Patent Application Publication
(10) Pub. No.: US 2008/0189392 A1
(43) Pub. Date: Aug. 7, 2008

(54) COMPUTER SYSTEM WITH LAN-BASED I/O

(75) Inventors: Alain Azagury, Nesher (IL); Michael Rodeh, Haifa (IL); Julian Satran, Atlit (IL); Ilan Shimony, Haifa (IL); T. Basil Smith, Wilton, CT (US); Dhruv M. Desai, Cary, NC (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/062,211

(22) Filed: Apr. 3, 2008

Related U.S. Application Data
(63) Continuation of application No. 10/735,321, filed on Dec. 12, 2003.

(51) Int. Cl. G06F 15/16

(52) U.S. Cl. 709/218

(57) ABSTRACT

A computer system includes a local area network (LAN) and a plurality of computers. Each of the computers includes at least one central processing unit (CPU) and a LAN interface, which is coupled to communicate over the LAN, while the computers include no on-board input/output (I/O) device controllers other than the LAN interface. One or more peripheral devices are coupled to communicate with the computers over the LAN.

### RELATED APPLICATIONS

The present Application is a Continuation Application of U.S. patent application Ser. No. 10/735,321 filed on Dec. 12, 2003.

### FIELD OF THE INVENTION

The present invention relates generally to computer systems, and specifically to systems in which computers are linked to peripheral devices via a packet network.

### BACKGROUND OF THE INVENTION

Nearly all current computer systems, from desktop personal computers through high-end servers, include multiple input/output (I/O) connections to peripheral devices. A typical computer has I/O connections for a video display, keyboard, mouse, floppy disk, USB ports, hard disks (SCSI and/or IDE), serial port, parallel port, audio, and local area network (LAN) interface. Each peripheral device is controlled by a specialized hardware controller, which on one side connects to the peripheral device, and on the other side connects to the rest of the computer system via one of several buses. The buses may be proprietary or standardized, such as the standard PCI, PCI-X, and AGP buses. These buses are typically connected to the central processing unit (CPU) through either one or two system controller chips, commonly referred to as the “North Bridge” and the “South Bridge.”

A number of new standards have recently been promulgated to permit accessing at least some I/O peripherals remotely, via packet networks. For example, the iSCSI protocol provides remote, SCSI-like disk access over Internet Protocol (IP) networks. As another example, the InfiniBand™ architecture permits computing hosts and peripheral to be linked by a switching network, commonly referred to as a switching fabric. The InfiniBand architecture is described in an article published by the InfiniBand® Trade Association (www.infinibandta.org/ibta/, 2003), entitled “An InfiniBand Technology Overview.” As noted in this article, InfiniBand provides a mechanism to remove I/O from the server chassis, so that I/O interconnects may be shared among many servers. This approach is said to permit design innovations such as dense server blade implementations.

### SUMMARY OF THE INVENTION

In embodiments of the present invention, a computer comprises a CPU and a LAN interface, along with local memory and a system controller for interfacing among these elements. Typically, the computer comprises no other on-board buses or I/O controllers, except for the LAN interface and the bus that is used to connect it to the system controller. All I/O traffic between the computer and peripheral devices is carried in data frames, for example, Ethernet frames containing IP packets, over a LAN to which the LAN interface is connected. The LAN interface thus performs dual functions, providing the computer with access to both network communications and I/O functions.

Eliminating specialized I/O controllers and buses from the computer conserves substantial board space and power, as well as reducing the complexity, cost and management effort that must be invested in the computer and increasing its MTBF. These enhancements are particularly meaningful, for example, in a server blade or cluster environment, in which much of the generic I/O functionality (other than disk access) is rarely needed. Multiple servers of this sort may be connected to the LAN in order to share I/O resources via their respective LAN interfaces. A user console may be connected to the LAN in order to permit a user, when required, to enter keyboard or mouse inputs to each of the servers via the LAN, and to view the video output therefrom as required, likewise via the LAN.

There is therefore provided, in accordance with an embodiment of the present invention, a computer system, including:

a local area network (LAN);

a plurality of computers, each of the computers including at least one central processing unit (CPU) and a LAN interface, which is coupled to communicate over the LAN, while the computers include no on-board user interface controllers; and

a console, which includes user input and output devices and is coupled to communicate over the LAN so as to convey an input received via the user input device over the LAN to each of the computers, and to receive an output generated by each of the computers over the LAN for display using the user output device.

Typically, the computers and the console are arranged to communicate over the LAN by transmitting Layer 2 data frames. In one embodiment, the computers and the console are arranged to convey the input and the output by tunneling over Layer 2 on the LAN. In another embodiment, the computers and the console are arranged to encapsulate the input and output in Internet Protocol (IP) packets for transmission over the LAN. In an alternative embodiment, the computers and the console are arranged to encapsulate the input and output using an application-layer protocol.

In a disclosed embodiment, the system includes an input/output (I/O) device, coupled to the LAN, wherein the computers are arranged to transmit I/O commands over the LAN to the I/O device and include no on-board I/O device controllers. Typically, each of the computers includes an emulation processor, which is coupled to trap the I/O commands from the at least one CPU while emulating the I/O device, and to encapsulate the I/O commands in data frames for transmission over the LAN to the I/O device, so as to cause the I/O device to fulfill the commands.

There is also provided, in accordance with an embodiment of the present invention, computer apparatus, including:

a central processing unit (CPU);

a system controller, coupled to the CPU and arranged to generate input/output (I/O) commands for transmission over a bus to an I/O device;

a network interface, which is arranged to be coupled to a local area network (LAN); and

an emulation processor, which is coupled to the system controller and to the network interface, and is arranged to trap the I/O commands from the system controller while emulating the I/O device, and to encapsulate the I/O commands in data frames for transmission via the network interface over the LAN to the I/O device, so as to cause the I/O device to fulfill the commands.

In a disclosed embodiment, the apparatus includes substantially no on-board device controllers other than the network interface and the emulation processor.

There is additionally provided, in accordance with an embodiment of the present invention, an emulation device, including:

trap logic, which is arranged to be coupled to a computer system controller so as to trap input/output (I/O) commands directed by the system controller to an I/O device, while emulating the I/O device; and

a service processor, which is arranged to encapsulate the trapped I/O commands in data frames for transmission over a local area network (LAN) to the I/O device, so as to cause the I/O device to fulfill the commands.

There is further provided, in accordance with an embodiment of the present invention, a method for computing, including:

coupling a plurality of computers to communicate over a local area network (LAN), the computers including no on-board user interface controllers; and

coupling a console, which includes user input and output devices, to communicate over the LAN so as to convey an input received via the user input device over the LAN to each of the computers; and

receiving an output generated by each of the computers over the LAN for display using the user output device.

There is moreover provided, in accordance with an embodiment of the present invention, a computer system, including:

a local area network (LAN);

a plurality of computers, each of the computers including at least one central processing unit (CPU) and a LAN interface, which is coupled to communicate over the LAN, while the computers include no on-board input/output (I/O) device controllers other than the LAN interface; and

one or more peripheral devices, coupled to communicate with the computers over the LAN.

There is furthermore provided, in accordance with an embodiment of the present invention, a method for computing, including:

coupling a plurality of computers to communicate over a local area network (LAN) via respective LAN interfaces, the computers including no on-board input/output (I/O) device controllers other than the LAN interfaces; and

coupling one or more peripheral devices to communicate with the computers over the LAN; and

controlling the peripheral devices by transmitting I/O commands over the LAN from the computers to the peripheral devices.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer system, in accordance with an embodiment of the present invention; and

FIG. 2 is a block diagram that schematically shows details of a computer with LAN-based I/O, in accordance with an embodiment of the present invention.

### DETAILED DESCRIPTION OF EMBODIMENTS

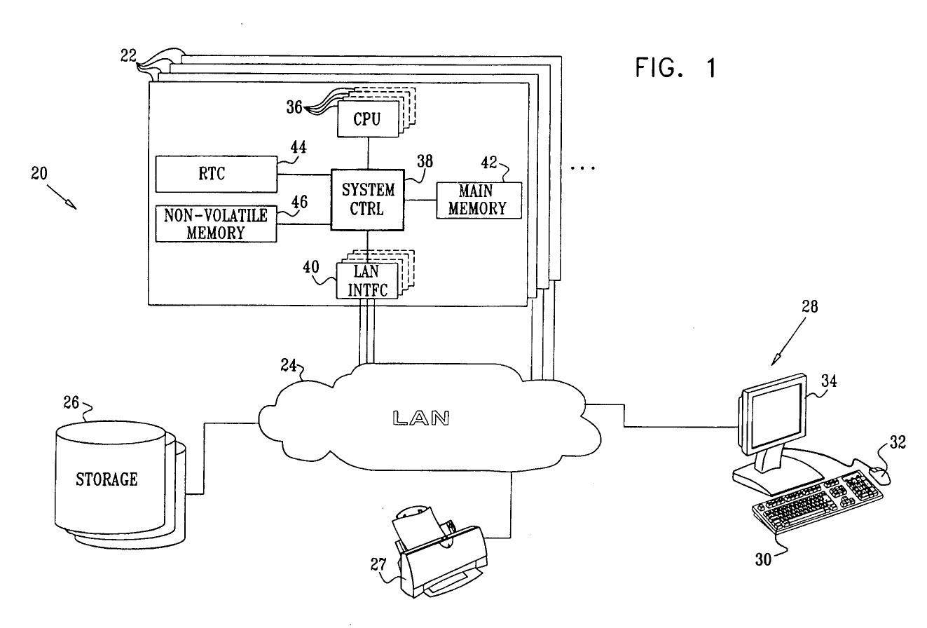

FIG. 1 is a block diagram that schematically illustrates a computer system 20, in accordance with an embodiment of the present invention. System 20 comprises multiple “busless” computers 22, which communicate with one another and with peripheral devices via a LAN 24. For example, system 20 may be a server cluster or other multi-server system, in which case computers 22 are configured as servers, possibly server blades. Alternatively, the principles of the present invention may similarly be applied in other sorts of multi-computer systems.

Computers 22 use LAN 24 both for conventional network communications—with other computers in system 20 and with computers outside the system—and for I/O functions. In the present example, computers 22 may access storage devices 26, such as a hard disk or disk array, via LAN 24. Typically, the computers comprise no local storage. Other peripheral devices, such as a printer 27, may likewise be connected for remote access via the LAN. In an exemplary embodiment, computers 22 communicate over LAN 24 by transmitting and receiving IP packets, and suitable IP-based protocols are provided for accessing the peripheral devices. For example, the computers may access storage device 26 using the iSCSI protocol. As another example, computers 22 may access peripheral devices using application-level protocols, as are known in the art, such as the Hypertext Transfer Protocol (HTTP) or Virtual Network Computing (VNC). Alternatively or additionally, computers 22 may communicate with peripheral devices by transmitting and receiving Layer 2 data frames, such as Ethernet frames, over LAN 24. In this case, suitable tunneling protocols may be used to encapsulate storage commands and data, and similarly other I/O signals, in the Layer 2 frames.

A console 28 permits the system operator or other user to access each of computers 22. Note that computers 22 have no on-board user interface devices, such as a video adapter, keyboard adapter or serial port. Rather, a keyboard 30, mouse 32 and video monitor 34 are provided as part of console 28. Keyboard and mouse inputs by the user of console 28 are encapsulated in IP packets or Layer 2 data frames for transmission over LAN 24 to the selected computer 22. Video signals generated by the computer are similarly encapsulated and transmitted to console 28 for display on monitor 34. If computer 22 is running a Unix® or Linux®-type operating system, the X-Windows protocol may be used for communication between the computer and console 28. Alternatively, for operating systems such as Microsoft Windows®, computer 22 and console 28 may be provided with video drivers that encapsulate and de-encapsulate Windows Graphic Device Interface (GDI) commands in IP packets.

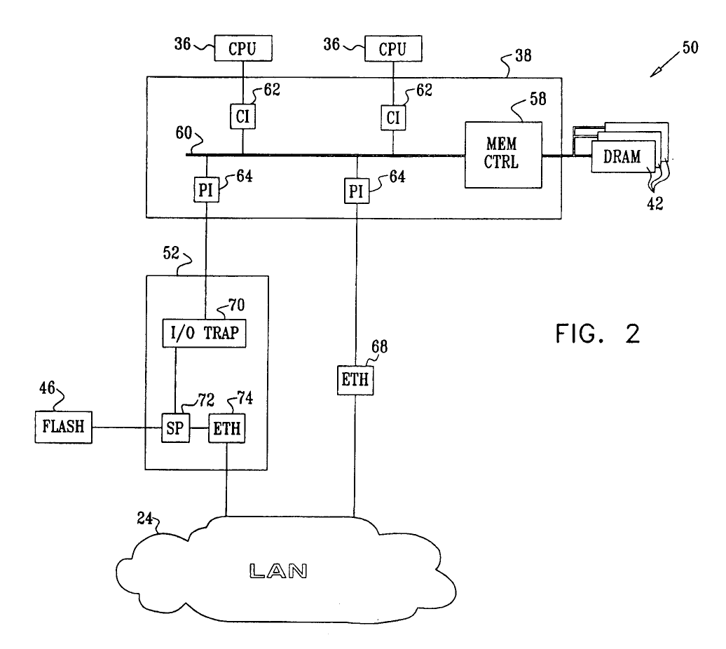

Each computer 22 comprises one or more CPUs 36, which are coupled by a system controller 38 to one or more LAN interfaces 40. Details of an exemplary system controller and LAN interface circuits are shown in FIG. 2 and described hereinbelow. Typically, controller 38 also couples CPUs 36 to local main memory 42, such as dynamic random access memory (DRAM), and to a real-time clock (RTC) 44, as is known in the art. In addition, computer 22 may comprise a non-volatile memory 46, such as flash memory, which holds the basic input/output system (BIOS) commands that are used by computer 22 during the initial stages of boot-up. Additionally or alternatively, computer 22 may boot remotely over network 24, using a network-based boot protocol stack, for example, via a TCP/IP connection to storage device 26 where the boot data are stored.

Computer 22 may perform the network-based boot and I/O access functions described herein under the control of software, which is typically stored in non-volatile memory 46 and/or on storage device 26. This software may be provided in electronic form, by download over network 24, for example, or it may alternatively be supplied on tangible media, such as CD-ROM or non-volatile memory.

FIG. 2 is a block diagram that schematically shows details of a computer 50, in accordance with an embodiment of the present invention. Computer 50 may perform the functions of computers 22 in system 20, or it may alternatively be used in other computer system configurations. In the present embodiment, computer 50 is configured specifically as a server blade. In this configuration, the computer occupies a single printed circuit board, which is mounted on a backplane in a rack together with other, similar boards—typically ten or more boards in a single box. This configuration permits multiple blades to be accessed and controlled remotely over LAN 24 using console 28, wherein the blades may be accessed individually or simultaneously. The present invention is particularly useful in the multi-blade server environment, since the blades generally do not make use of much I/O functionality, other than storage and network access. The principles embodied in the design of computer 50, however, may also be implemented in computers of other types.

For convenience of implementation, computer 50 comprises a number of legacy components, which are used in existing, bus-based server blades. For example, CPUs 36 may be Xeon processors, made by Intel Corp. (Santa Clara, Calif.), while system controller 38 is an off-shelf North Bridge device, such as a LE-type chip produced by the ServerWorks division of Broadcom Corp. (Irvine, Calif.). This system controller chip comprises a memory controller 58, for interfacing with local memory 42, as well as CPU interface ports 62 for coupling to CPUs 36, and peripheral interface ports 64. The elements of controller 38 are linked together by an internal bus 60. It will be understood that the specific components mentioned here and the internal structure and arrangement of these components are described here only by way of example. Alternative realizations of the principles of the present invention will be apparent to those skilled in the art.

One of ports 64 of controller 38 is connected to a fast Ethernet interface 68, such as a Broadcom BMC5703S Gigabit Ethernet controller. (If desired, a bus bridge, not shown in the figures, may be used to connect port 64 to multiple parallel Ethernet interfaces.) Ethernet interface 68 connects to LAN 24. In the server blade environment, the LAN connection is typically made via a backplane connector to LAN wiring in a backplane of the server rack (not shown) in which computer 50 is mounted.

In order to make these legacy components work in the novel, LAN-based I/O architecture of the present invention, computer 50 comprises a novel “legacy emulation” (LEM) device 52 (which may also be referred to as an emulation processor), which interfaces between system controller 38 and LAN 24. Device 52 typically comprises a semi-custom or field-programmable chip, such as an ASIC or FPGA chip. Although device 52 is shown, for the sake of clarity of explanation, as comprising a number of different functional blocks, all these functions may be performed by a single chip. Alternatively or additionally, device 52 may comprise two or more separate chips, or a single custom chip.

LEM device 52 comprises I/O trap logic 70, which is connected to one of peripheral interface ports 64 of controller 38. Logic 70 intercepts outputs sent by CPUs 36 to peripheral devices, including:
Graphic outputs (for example, VGA-type commands and data) to drive a video display.
Audio outputs.
Outputs directed to serial, parallel and USB ports.

In a legacy computer architecture, these outputs would be passed from controller 38 over appropriate buses to the peripheral devices themselves, possibly via a South Bridge device. Instead, in computer 50, logic 70 traps the output data and commands, and passes them to a service processor 72, which encapsulates these outputs in packets for transmission to the appropriate peripheral devices via LAN 24. Logic 70 emulates the behavior of the appropriate I/O controllers, so that CPU 36 and system controller 38 are not aware that the I/O functions are being performed remotely.

To communicate with peripheral devices, service processor 72 typically establishes TCP/IP connections over LAN 24 with the controllers of the peripheral devices. Service processor 72 transmits the TCP/IP packets via a dedicated Ethernet interface 74 to LAN 24. Alternatively, the service processor may use the existing Ethernet interface 68 to transmit and receive packets over the LAN if the interface is not required for other communication traffic. As a further alternative, Ethernet interface 74 may be connected to the LAN via a hub (not shown), to which interface 68 is also connected.

Similarly, service processor 72 receives packets over TCP/IP connections containing inputs from peripheral devices, such as keyboard 30, mouse 32 and other data inputs. The service processor de-encapsulates the inputs and conveys them to logic 70, which then passes the inputs via controller 38 to CPU 36. As noted above, logic 70 virtualizes and emulates the behavior of conventional, standard I/O devices. Computer 50 may thus run a standard operating system, such as Windows®, substantially without modification. CPU 36 and controller 38 need not be aware that they are dealing with remote peripherals via LAN 24, rather than local peripherals connected by conventional I/O buses.

Service processor 72 also interfaces with non-volatile memory 46, in order to initiate the boot sequence of computer 50 upon power-up or reset. Real-time clock 44 is omitted from FIG. 2 for the sake of simplicity.

Where network-based I/O protocols are available, computer 50 may be programmed to use these protocols, rather than I/O emulation via LEM device 52. For example, the computer may be programmed to access disks using the iSCSI protocol via one of Ethernet interfaces 68. Similarly, as noted above, network boot and X-Windows may be used for remote boot and console interface functions when computer 50 is running an operating system that is compatible with these protocols.

Comparing computer 50 to server blades known in the art, it will be observed that computer 50 has a substantially smaller chip count: no South Bridge, and no interface or controller chips for keyboard, mouse, video, audio, USB, serial and parallel ports or disks. Therefore, computer 50 consumes less power, is less costly to produce, and can be packed more densely into server racks than can server blades known in the art. Although FIG. 2 shows one particular implementation, variations will be apparent to those skilled in the art. For example, computer 50 may comprise more or fewer CPUs, as well as more or fewer Ethernet ports, depending on application requirements. To accelerate communication functions, the computer may include additional protocol offload devices, such as hardware-based TCP/IP and iSCSI interface chips.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer system, comprising:
a local area network (LAN);
a plurality of computers, each of the computers comprising at least one central processing unit (CPU) and a LAN interface, which is coupled to communicate over the LAN, while the computers comprise no on-board user interface controllers; and
a console, which comprises user input and output devices and is coupled to communicate over the LAN so as to convey an input received via the user input device over the LAN to each of the computers, and to receive an output generated by each of the computers over the LAN for display using the user output device.

2. The system according to claim 1, wherein the computers and the console are arranged to communicate over the LAN by transmitting Layer 2 data frames.

3. The system according to claim 2, wherein the computers and the console are arranged to convey the input and the output by tunneling over Layer 2 on the LAN.

4. The system according to claim 2, wherein the computers and the console are arranged to encapsulate the input and output in Internet Protocol (IP) packets for transmission over the LAN.

5. The system according to claim 2, wherein the computers and the console are arranged to encapsulate the input and output using an application-layer protocol.

6. The system according to claim 1, and further comprising an input/output (I/O) device, coupled to the LAN, and wherein the computers are arranged to transmit I/O commands over the LAN to the I/O device and comprise no on-board I/O device controllers.

7. The system according to claim 6, wherein each of the computers comprises an emulation processor, which is coupled to trap the I/O commands from the at least one CPU while emulating the I/O device, and to encapsulate the I/O commands in data frames for transmission over the LAN to the I/O device, so as to cause the I/O device to fulfill the commands.

8. Computer apparatus, comprising:
a central processing unit (CPU);
a system controller, coupled to the CPU and arranged to generate input/output (I/O) commands for transmission over a bus to an I/O device;
a network interface, which is arranged to be coupled to a local area network (LAN); and
an emulation processor, which is coupled to the system controller and to the network interface, and is arranged to trap the I/O commands from the system controller while emulating the I/O device, and to encapsulate the I/O commands in data frames for transmission via the network interface over the LAN to the I/O device, so as to cause the I/O device to fulfill the commands.

9. The apparatus according to claim 8, wherein the emulation processor is arranged to encapsulate the I/O commands in Ethernet frames.

10. The apparatus according to claim 8, wherein the emulation processor is arranged to encapsulate the I/O commands in Internet Protocol (IP) packets.

11. The apparatus according to claim 8, wherein the emulation processor is arranged to encapsulate the I/O commands using an application-layer protocol.

12. The apparatus according to claim 8, wherein the apparatus comprises substantially no on-board device controllers other than the network interface and the emulation processor.

13. An emulation device, comprising:
trap logic, which is arranged to be coupled to a computer system controller so as to trap input/output (I/O) commands directed by the system controller to an I/O device, while emulating the I/O device; and
a service processor, which is arranged to encapsulate the trapped I/O commands in data frames for transmission over a local area network (LAN) to the I/O device, so as to cause the I/O device to fulfill the commands.

14. The device according to claim 13, wherein the service processor is arranged to encapsulate the I/O commands in Ethernet frames.

15. The device according to claim 13, wherein the service processor is arranged to encapsulate the I/O commands in Internet Protocol (IP) packets.

16. The device according to claim 13, wherein the service processor is arranged to encapsulate the I/O commands using an application-layer protocol.

17. A method for computing, comprising:
coupling a plurality of computers to communicate over a local area network (LAN), the computers comprising no on-board user interface controllers; and
coupling a console, which comprises user input and output devices, to communicate over the LAN so as to convey an input received via the user input device over the LAN to each of the computers; and
receiving an output generated by each of the computers over the LAN for display using the user output device.

18. The method according to claim 17, wherein coupling the computers and the console comprises arranging the computers and the console to communicate over the LAN with the console by transmitting Layer 2 data frames.

19. The method according to claim 18, wherein the computers and the console are arranged to convey the input and the output by tunneling over Layer 2 on the LAN.

20. The method according to claim 18, wherein the computers and the console are arranged to encapsulate the input and output in Internet Protocol (IP) packets for transmission over the LAN.

21. The method according to claim 18, wherein the computers and the console are arranged to encapsulate the input and output using an application-layer protocol.

22. The method according to claim 17, and further comprising coupling an input/output (I/O) device to the LAN, and arranging the computers to transmit I/O commands over the LAN to the I/O device, wherein the computers comprise no on-board I/O device controllers.

23. The method according to claim 22, wherein arranging the computers to transmit I/O commands over the LAN comprises trapping the I/O commands while emulating the I/O device, using an emulation device in each of the computers, and encapsulating the I/O commands in data frames for transmission over the LAN to the I/O device, so as to cause the I/O device to fulfill the commands.

24. A computer system, comprising:
a local area network (LAN);
a plurality of computers, each of the computers comprising at least one central processing unit (CPU) and a LAN interface, which is coupled to communicate over the LAN, while the computers comprise no on-board input/output (I/O) device controllers other than the LAN interface; and
one or more peripheral devices, coupled to communicate with the computers over the LAN.

25. The system according to claim 24, wherein the computers and the peripheral devices are arranged to communicate over the LAN by transmitting Layer 2 data frames.

26. The system according to claim 25, wherein the computers and the peripheral devices are arranged to communicate by tunneling over Layer 2 on the LAN.

27. The system according to claim 25, wherein the computers and the peripheral devices are arranged to communicate by encapsulating I/O commands in Internet Protocol (IP) packets for transmission over the LAN.

28. The system according to claim 25, wherein the computers and the peripheral devices are arranged to communicate by encapsulating I/O commands using an application-layer protocol.

29. The system according to claim 25, wherein the Layer 2 data frames are Ethernet frames.

30. The system according to claim 24, wherein the at least one CPU of each of the computers is arranged to generate I/O commands for controlling at least one of the peripheral devices, and wherein each of the computers comprises an emulation processor, which is coupled to trap the I/O commands from the at least one CPU while emulating the at least one of the peripheral devices, and to encapsulate the I/O commands in data frames for transmission over the LAN to the at least one of the peripheral devices, so as to cause the at least one of the peripheral devices to fulfill the commands.

31. A method for computing, comprising:
coupling a plurality of computers to communicate over a local area network (LAN) via respective LAN interfaces, the computers comprising no on-board input/output (I/O) device controllers other than the LAN interfaces; and
coupling one or more peripheral devices to communicate with the computers over the LAN; and
controlling the peripheral devices by transmitting I/O commands over the LAN from the computers to the peripheral devices.

32. The method according to claim 31, wherein controlling the peripheral devices comprises transmitting Layer 2 data frames over the LAN.

33. The method according to claim 32, wherein transmitting the Layer 2 data frames comprises conveying the I/O commands by tunneling over Layer 2 on the LAN.

34. The method according to claim 33, wherein transmitting the Layer 2 data frames comprises conveying the I/O commands by encapsulating the I/O commands in Internet Protocol (IP) packets for transmission over the LAN.

35. The method according to claim 33, wherein transmitting the Layer 2 data frames comprises conveying the I/O commands by encapsulating the I/O commands using an application-layer protocol.

36. The method according to claim 33, wherein transmitting the Layer 2 data frames comprises transmitting Ethernet frames.

37. The method according to claim 32, wherein each of the computers comprises at least one CPU, which is arranged to generate the I/O commands, and wherein controlling the peripheral devices comprises trapping the I/O commands while emulating the at least one of the peripheral devices, using an emulation device in each of the computers, and encapsulating the I/O commands in data frames for transmission over the LAN to the at least one of the peripheral devices, so as to cause the at least one of the peripheral devices to fulfill the commands.
